(19) United States
(12) Patent Application Publication
(10) Pub. No.: US 2022/0202546 A1
(43) Pub. Date: Jun. 30, 2022

(54) SUCTION APPARATUS AND SALIVA EJECTOR

(71) Applicant: Daniel Tevrizian, San Marcos, CA (US)

(72) Inventor: Daniel Tevrizian, San Marcos, CA (US)

(21) Appl. No.: 17/399,537

(22) Filed: Aug. 11, 2021

Related U.S. Application Data
(63) Continuation of application No. PCT/US19/60007, filed on Nov. 6, 2019.
Application No. PCT/US19/60007 is a continuation-in-part of application No. 16/272,109, filed on Feb. 11, 2019.

(51) Int. Cl. A61C 17/06; A61C 17/08; A61C 17/10; A61C 17/12

(52) U.S. Cl. CPC A61C 17/096; A61C 17/08; A61C 17/125; A61C 17/10; A61C 17/092

(57) ABSTRACT

The present invention provides an apparatus adapted for ejection of material, e.g., saliva, from the mouth of a patient during a dental procedure. The apparatus has at least two distal openings such that material may be ejected simultaneously from at least two locations within the patient's mouth. The invention provides a suction apparatus having a proximal tube, which may couple with a standard waste container apparatus having a suction source.

### CROSS-REFERENCES TO RELATED APPLICATIONS

This application is a continuation of International Application No. PCT/US19/60007, filed Nov. 6, 2019, which is a continuation-in-part of U.S. application Ser. No. 16/272,109, filed Feb. 11, 2019, both of which are incorporated herein by reference in their entireties for all purposes.

### FIELD OF THE INVENTION

The invention generally relates to apparatus adapted for ejection of material from the mouth of a dentistry patient.

### BACKGROUND OF THE INVENTION

Dental procedures often require a patient's mouth, or a portion of a patient's mouth to be kept relatively dry and clean of debris. Typically, while a dental practitioner performs a procedure, an assistant wields a saliva ejector device having a formable tube with one distal opening that receives saliva and other debris from the patient's mouth. Periodically, the dental practitioner pauses the procedure, and then the assistant passes the ejector device across excess material accumulating in and around the patient's mouth. In some cases, the distal opening of the ejector device may be formed into a hook-like shape and placed into the patient's mouth without the aid of an assistant, or the patient may be asked to close her lips around the ejector device, temporarily holding it in place.

The usual requirement that an assistant occasionally pass the device around the interior of the patient's mouth may be interruptive and inefficient for both the dental practitioner and the patient. Furthermore, the alternation between accumulation and removal of material may keep the patient's mouth insufficiently dry for a particular procedure.

Alternatively, portions of a patient's mouth may be kept dry by use of dams, absorbents, or other means. Such solutions may be obtrusive, bulky, uncomfortable, and inadequate.

### SUMMARY OF THE INVENTION

The present invention provides an apparatus adapted for improved ejection of material, e.g., saliva, from the mouth of a patient during a dental procedure, and related methods. The inventive apparatus may be alternatively referred to as a suction apparatus and saliva ejector. Generally, the inventive suction apparatus is designed to be connected to a suction/vacuum source and a waste collection container. The vacuum source provides the negative pressure to draw saliva and other debris from the oral cavity into the apparatus and eventually to the waste collection container.

In one aspect, the invention provides an apparatus comprising (i) a proximal tube having a first diameter, wherein the proximal tube is rigid, semi-rigid, or formable and adapted on the proximal end for connection to a suction and waste container apparatus, and (ii) two or more distal tubes each terminating in a porous extraction port and each having a second diameter smaller than the first diameter, wherein the distal tubes are flexible and in fluid communication with the proximal tube, wherein the porous extraction ports are sized for placement within an oral cavity of a subject.

In another aspect, the invention provides an apparatus comprising (i) a first tube and a second tube each having a proximal end and a distal end, wherein the tubes are adapted on the proximal end for connection to a suction and waste container apparatus, (ii) a first flexible tube and a second flexible tube in fluid communication with and attached to the distal end of the first tube and the second tube, respectively, and (iii) a first porous extraction port and a second porous extraction port distal to and in fluid communication with the first flexible tube and second flexible tube, respectively, wherein the porous extraction ports are sized for placement within an oral cavity of a subject. Optionally, the apparatus further comprises a first rigid or semi-rigid elbow tube disposed between the first flexible tube and the first extraction port, and a second rigid or semi-rigid elbow tube disposed between the second flexible tube and the second extraction port. The first tube and the second tube may be rigid, semi-rigid, or formable. Optionally, the first tube and the second tube each comprise a bend in the distal half of the tube and positioned in a manner that, in use, the bend secures the apparatus over the mandibular arch and the extraction ports are configured to be positioned in the lingual and/or buccal sulci.

In some embodiments of the foregoing aspects, the extraction ports comprise a central lumen in fluid communication with the distal tubes. In some embodiments, the extraction ports comprise a cotton roll. In some embodiments, the extraction ports comprise tubes with side openings. In some embodiments, the extraction ports are sized for placement within a buccal sulcus or a lingual sulcus.

In some embodiments, the apparatus comprises two, three, four, or more extraction ports. In other embodiments, the apparatus comprises two, three, four, or more distal tubes.

In one aspect, the invention provides an apparatus (e.g., a saliva extractor) comprising (a) a Y-connector having a single vacuum input and a first and a second output, the outputs in fluid communication with the input, and the input adapted for connection to a vacuum source and waste container; (b) a first tube and a second tube each having a proximal end and a distal end, wherein the first and second tubes are adapted on their proximal ends for connection to the first and second outputs, respectively; and (c) a first and second extractor assembly in fluid communication with the first and second tubes, respectively, each comprising in proximal to distal order: a rigid or semi-rigid elbow configured to support the saliva extractor over the incisal edge of a subject; a flexible tube; and an extraction port comprising fenestrations configured to allow the passage of fluid into the extraction port interior and sized for placement within a buccal sulcus or a lingual sulcus of a subject.

In some embodiments, the Y-connector is configured to accept vacuum source tubes of only a single size. In other embodiments, the Y-connector is configured to accept vacuum source tubes of two, three, four, or more different sizes.

In some embodiments, the Y-connector contains a backflow prevention valve.

In some embodiments, the first and second elbow is detachably connected with the first and second tubes, respectively. Alternatively, the first and second elbow and the first and second tubes, respectively, are unitary elements (e.g., manufactured as a single element or manufactured as separate elements and subsequently fused).

In some embodiments of any of the foregoing aspects of the invention, the apparatus further comprises a tongue guard attached to an extraction port, wherein the tongue guard is configured to hold the tongue of a subject in a medial position relative to the extraction port. The tongue guard may be permanently affixed to the extraction port or may be slidably engaged in a longitudinal direction with the extraction port. If slidably engaged, in some embodiments, the tongue guard and extraction port may comprise complimentary detents and grooves adapted to hold the tongue guard in one of a plurality of longitudinal positions on the extraction port.

In some embodiments, the single vacuum input of the Y-connector is adapted to receive a vacuum input tube having a first diameter or a vacuum input tube having a second diameter, wherein the first diameter is larger than the second diameter.

In another aspect, the invention provides a method for extracting saliva from a subject's mouth comprising:
(a) providing the apparatus of any one of the foregoing aspects;
(b) placing a first extraction port in a lingual sulcus or a buccal sulcus;
(c) placing a second extraction port in a lingual sulcus or a buccal sulcus; and
(d) applying a suction to the apparatus through the proximal tube, wherein the suction is sufficient to extract saliva from the subject's mouth through at least on of the extraction ports.

In some embodiments, the subject is a human or an animal. In other embodiments, the subject is a cat or a dog.

In some embodiments, one extraction port is placed in each lingual sulcus, one extraction port is placed in each buccal sulcus, or both. In another embodiment, one extraction port is placed in a buccal sulcus and another extraction port is placed in a lingual sulcus.

By “distal,” when referring to the inventive device, is meant toward the patient and away from the suction source. For example, the distal end(s) of the inventive device are the material extraction ports that are placed within the patient's mouth.

By “flexible,” when referring to a tube is meant one that has little to no linear rigidity and may be bent over a larger working range of angles than formable and semi-rigid tubes. Flexible tubes do not tend to return to a previous shape and do not readily maintain any particular shape and, therefore, do not add any significant structural support or rigidity to the device.

By “formable,” when referring to a tube including, for example, the proximal tube, is meant a tube that is semi-rigid such that the user may deform or otherwise shape the tube without damage to the tube wall or loss of patency and wherein the tube retains the formed shape. For example, standard saliva extractors known in the art are formable in that the suction tube is manufactured in a linear configuration but the user (e.g., dentist) may bend the extractor to facilitate saliva extraction in hard-to-reach areas of the oral cavity and/or to provide light retraction of soft tissues such as the cheeks and lips.

By “proximal,” when referring to the inventive device, is meant toward the suction source and away from the patient.

By “rigid,” when referring to a tube is meant one that cannot be significantly bent or otherwise deformed without a substantial risk of damage to the tube wall and/or loss of patency, and wherein the tube will not retain a deformed shape after the deformation pressure is released.

By “semi-rigid,” when referring to a tube is meant one that may be bent within a significant working range of angles without damage to the tube wall and/or loss of patency. Semi-rigid tubes may retain a deformed shape (i.e., also be “formable”) or may return or have bias to return to its original (e.g., manufactured) shape.

By “vacuum source tube” is meant the most proximal vacuum line into which a disposable or autoclavable saliva extractor may be attached. A saliva extractor may be attached directly to the vacuum source tube or through an adapter. In some embodiments, the vacuum source is neither removable nor autoclavable and represents a fixed element that is used with multiple patients without substantial cleaning, sterilization, or replacement for each patient.

By “waste container apparatus” is meant a system which comprises a vacuum source (e.g., pump) and a waste collection container, as is typically used in dental and related procedures as described herein. Other tubing and fittings generally accompany the waste container apparatus in order to functionally connect that apparatus to the instrument (e.g., suction apparatus) used in the medical/dental procedure.

### DESCRIPTION OF THE DRAWINGS

The present invention may be better understood by referring to the following figures. The components in the figures are not necessarily to scale, emphasis instead being placed upon illustrating the principles of the disclosure. In the figures, reference numerals designate corresponding parts throughout the different views.

FIG. 1 is a schematic of a first implementation of a suction apparatus.

FIG. 2 is a perspective view of one exemplary placement of the material extraction ports on the buccal and lingual sides of a patient's mandibular arch.

FIG. 3 is a schematic of a second implementation of a suction apparatus.

FIG. 4A is a schematic side view illustrating one possible positioning of the suction apparatus in relation to the lower mandible of a subject. FIG. 4B is a schematic top view illustrating one possible positioning of the extraction ports relative to the lower mandible of a subject.

FIG. 5 is a schematic of a third implementation of a suction apparatus.

FIG. 6 is a schematic of a fourth implementation of a suction apparatus.

FIG. 7A is a longitudinal view of one embodiment of a Y-connector. FIG. 7B is a side view of that Y-connector embodiment.

FIG. 8 is a schematic of a detachable elbow in combination with a flexible tube and an extraction port.

FIG. 9 is a schematic of a tongue guard.

FIG. 10 is a schematic of a tongue guard in combination with a detachable elbow, a flexible tube and an extraction port.

### DETAILED DESCRIPTION

The following description sets forth the invention and method of use in several embodiments. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

Saliva ejectors are commonly used by a dentist, dental hygienist, or other person of skill in the art who might require the removal of material such as saliva, blood, irrigation fluid (e.g., water), and other debris and fluid from a patient's oral cavity during a dental procedure. The present invention provides an improved saliva ejector having multiple extraction ports through which the unwanted/waste material (fluid) is removed by suction created by an external vacuum source (pump).

One purpose of the invention is to provide a saliva ejector having multiple extraction ports in order to more fully and efficiently remove unwanted fluids and debris from the oral cavity during a dental, medical, or surgical procedure. Generally, the ejector contains two extraction ports but it may be desirable to construct ejectors having three, four, or more extraction ports for use in certain procedures. Where the following descriptions refer to ejectors having two extraction ports, it is understood that additional extraction ports may be included for placement in other areas of the oral cavity. The extraction ports may be placed in any suitable location within the oral cavity and particularly in locations at which saliva and other fluids collect. For example, extraction ports may be placed into (i) the left and right lingual sulci, (ii) ipsilateral lingual sulcus and a buccal sulcus (e.g., the right lingual sulcus and right buccal sulcus or the left lingual sulcus and left buccal sulcus), (iii) contralateral lingual sulcus and a buccal sulcus (e.g., the right lingual sulcus and left buccal sulcus or the left lingual sulcus and right buccal sulcus), (iv) the left and right buccal sulci, and (v) higher order combinations thereof.

While in preferred embodiments, the suction apparatus is used to extract material from a human dental patient's oral cavity, the present invention is not necessarily limited to application in human dentistry patients and could be used in non-human dental applications and/or non-dental medical applications. The sizing, configuration, and positioning of the various elements may be varied as appropriate for the desired use without departing from the spirit and scope of the invention.

Another purpose of the invention is to provide a saliva ejector that stays in place by itself without the need for to be manually held in place. It is common practice during dental, medical, and surgical procedures within the oral cavity to for the clinician (e.g., surgeon or dentist) who is performing the procedure to be assisted by another individual (e.g., a dental hygienist, nurse, or other assistant), wherein the assistant is responsible for positioning and operating a saliva ejector. In many instances, the assistant is required to hold the saliva ejector for the entirety of the procedure, leaving the assistant unable or with reduced capacity to assist the clinician with the procedure. Accordingly, it is desirable to have a saliva ejector that may be positioned in various locations within the oral cavity and that does not require constant attention by an operator. Such a device would allow a clinician to perform certain procedures without an assistant and/or would free the assistant to perform other tasks required by the procedure.

Another purpose of the invention is to provide a hands-free tongue guard to obstruct the patient's tongue from other tools implemented within the oral cavity. Small mouth mirrors held by the clinician and/or assistant are typically used for this purpose, but these require continual manual manipulation. Accordingly, it is desirable to have a hands-free tongue guard that may be positioned within the oral cavity and that may free up the hands of the operators.

In various aspects, the inventive saliva ejector generally comprises two or more extraction ports attached directly or indirectly to flexible tubing which facilitates comfortable and secure placement of the extraction ports at the target locations within the oral cavity. The flexible tubing attaches to formable tubing which is bendable by the operator but holds its shape under normal usage conditions. The formable tubing is connected directly or indirectly to a vacuum pump that provides the suction required to draw the fluids and debris from the oral cavity through the extraction ports, and to a collection vessel (waste container) that traps the unwanted fluid and debris for later disposal.

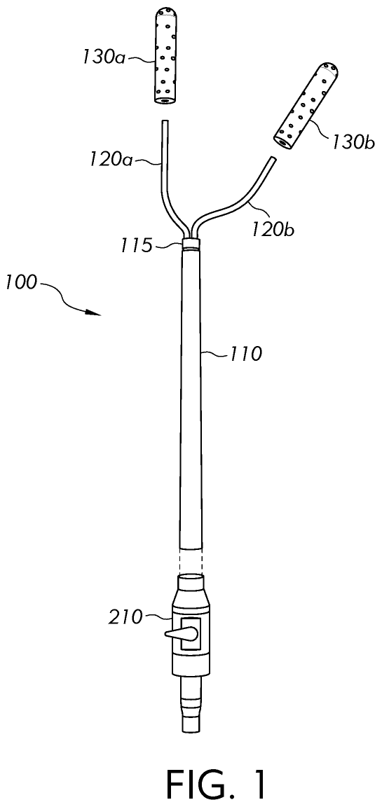

FIG. 1 provides an exploded view of one implementation of suction apparatus 100, shown ex situ. Suction apparatus 100 comprises a proximal tube 110 and a pair of flexible or semi-flexible distal tubes 120a, 120b attached to and in fluid communication with distal end of proximal tube 110. While FIG. 1 depicts two distal tubes 120a, 120b, in some embodiments, there may be 2, 3, 4, or more distal tubes. The distal ends of distal tubes 120a, 120b terminate in, and are in fluid communication with material extraction ports 130a, 130b. Extraction ports 130, distal tubes 120, proximal tube 110 are in fluid communication and the proximal end of the proximal tube 110 is operationally coupled to a waste container (not shown) and vacuum source (not shown) that generates a negative gas pressure sufficient to drawn waste fluids and debris through extraction ports 130. In some embodiments, the waste container and vacuum source have a standard configuration as is commonly found in dental offices. For example, optional adapter 210 is adapted to connect suction apparatus 100 to suction and waste collections systems standard and common in dental offices.

Optionally, distal tubes 120 may be connected to proximal tube 110 through end cap 115. In this embodiment, end cap 115 forms a reversible or irreversible connection with proximal tube 110. Optionally, end cap 115 comprises a plurality of holes in a top surface equal to the number of distal tubes 120 connected to end cap 115, wherein distal tubes 120 extend in the distal direction through the holes. Distal tubes 120 may have a flange, stopper, or other form of flared proximal end in order to secure distal tubes 120 to end cap 115. Many types of connections are known in the art and are suitable for connecting distal tubes 120 to proximal tube 110 provided that patency is maintained. Typically, proximal tube 110 has a greater cross-sectional area (diameter) than any individual distal tube 120 or all distal tubes 120 collectively. Thus, one purpose and configuration of end cap 115 is to form a junction between a plurality of distal tubes 120 and proximal tube 110.

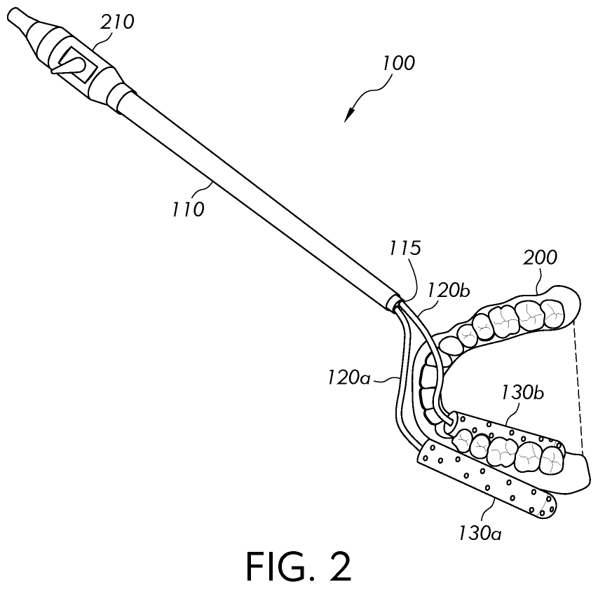

Proximal tube 110 and distal tubes 120 may be manufactured from any suitable material to any reasonable wall-thickness, diameter, and length. In some embodiment, the tubes are made from silicone, rubber, nylon, composite, polypropylene, PET, PTFE, and the like. In this implementation, distal tubes 120 are manufactured from a material and to specifications such that they may be easily and gently inserted into the patient's oral cavity, manipulated, positioned, arranged, adjusted, draped over the patient's mandibular arch, crimped, or removed. For example, FIG. 2 illustrates an exemplary placement of suction apparatus 100 along a patient's mandibular arch 200. Distal tubes 120a, 120b are freely movable so that the material extraction ports 130a, 130b may be placed in any desired location along the buccal sulci and/or lingual sulci. Suction apparatus 100 may be held in place simply by gravity and friction based on the positioning of the device on or against the patient. Optionally, an assistant may support suction apparatus 100 to ensure that material extraction ports 130 remain in the desired location within the oral cavity.

As shown in the exemplary placement in FIG. 2, the material extraction ports 130a, 130b are placed on the left buccal and left lingual sulci of the patient's mandibular arch 200. The suction apparatus 100 depicted in FIG. 2 has a proximal tube 110 fitted at its proximal end with an adapter 210 for fitting the suction apparatus 100 to standard dental suction units.

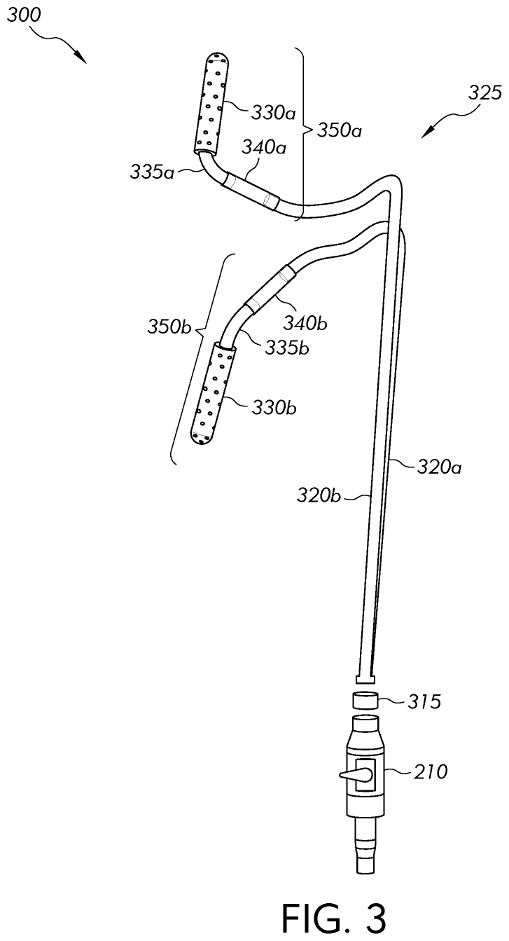

FIG. 3 provides a perspective view of another implementation of suction apparatus 300 which eliminates the proximal tube and instead connects the plurality of distal tubes directly to the adapter and vacuum source line. As in the previous implementation, adapter 210 provides a connection between suction apparatus 300 and the vacuum source/waste container system (not shown) and, optionally, may provide a user-operated ball valve or similar device to regulate fluid flow and suction. Distal tubes 320a,b are in fluid communication with and connected on their proximal ends to adapter 210. This connection may be direct or indirect. FIG. 3 illustrates that distal tubes 320a,b are connected to adapter 210 through endcap 315. Alternatively or in addition to endcap 315, the connection may comprise a portion of proximal tube (not shown). The selection and design of the connection may be routinely varied based on the principles and requirements of design and end use.

FIG. 3 also illustrates an alternate configuration for the distal ends of the distal tubes with may be used with any of the suction apparati described herein. In this embodiment, distal tubes 320a,b (with or without the presence of a proximal tube) are constructed from a rigid, semi-rigid, and/or formable material. A formable material is easily bendable by the user but retains its shape in use and under the weight of the device itself. The user is able to bend distal tubes 320a,b at bend 325 to bridge the teeth and/or mandibular arch 200 and maintain the desired placement of extraction ports 330a,b within the oral cavity. Distal tubes 320 may be manufactured to have a particular bend which may be unbendable or bendable by the user. Alternatively, distal tubes 320 may be manufactured in a linear or other convenient configuration of a bendable material such that the user can customize the bend and fit for each patient.

Distal tubes 320a,b are connected directly or indirectly to extraction ports 330a,b. Optionally, the connection is flexible in order to facilitate easy, secure, and comfortable placement of extraction ports 330a,b. In one embodiment, suction apparatus 300 optionally comprises flexible connector 350a,b that connects distal tubes 320a,b and extraction ports 330a,b, respectively. In one configuration, flexible connector 350 comprises, in proximal-to-distal order, flexible tube 340 and elbow 335 which connects distal tube 320 with extraction port 330. Elbow 335 may be rigid or semi-rigid, as necessary to facilitate placement and user comfort. In another embodiment, elbow 335 is omitted such that distal tube 320 is connected to extraction port 330 only through flexible tube 340.

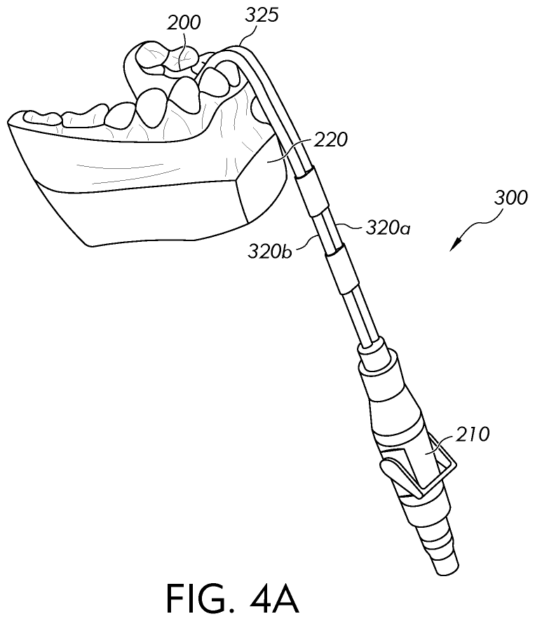

FIG. 4A shows a side view of suction apparatus 300 bridging the lower mandibular arch 200. Specifically, distal tubes 320a,b have bend 325 at a sufficient angle so as to maintain placement of extraction ports 330a,b (not shown) at the desired location. It is understood that bend 325 generally will have a less acute angle because dental patients typically are reclined in a supine position. FIG. 4B shows a top view of the lower mandible 220 for the positioning shown in FIG. 4A. Extraction ports 330a,b are shown as being positioned in the lingual sulci, however, one or both of extraction ports 330a,b could be positioned in the buccal sulci wherein neither or only one of bend 325a,b bridges the lower mandibular arch 200.

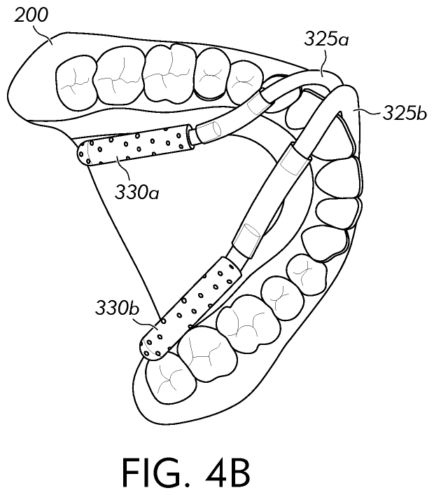

Although the inventive suction apparati are illustrated and described herein as being symmetrical, it is understood that the two sides may be asymmetrical. For example, one side may have a longer tube length than the other side to facilitate placement of extraction ports 330a,b in different bilateral locations. Furthermore, it is understood that the two sides need not have the same components and/or same arrangements. For example, FIG. 5 illustrates suction apparatus 400 in which one side has features of the first implementation and the other side has features of the second implementation. In this implementation, suction apparatus 400 comprises adapter 210, proximal tube 410, and end cap 415, as described above. First distal tube 421 is substantially the same as distal tubes 120 illustrated in FIG. 1 such that they are highly flexible and allow placement of extraction port 430a in any location within the oral cavity. Second distal tube 422 is substantially the same as distal tubes 320 illustrated in FIG. 3 and optionally may include flexible connector 450 comprising elbow 435 and/or flexible tube 440. In some embodiments, distal tube 422 is sufficiently rigid to support the weight of suction apparatus 400.

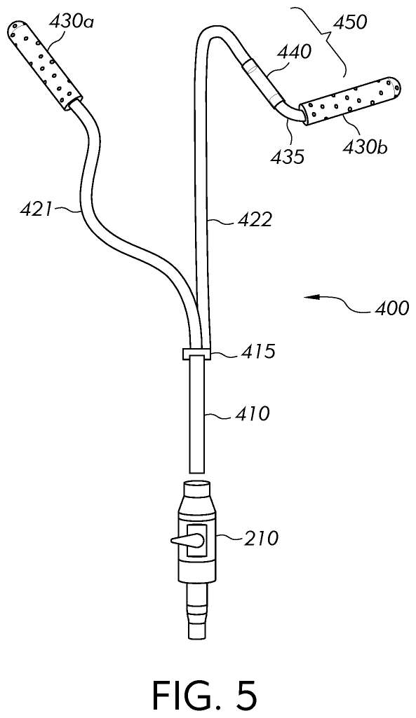

FIG. 6 provides a perspective view of another implementation of suction apparatus 500. As in the previous implementations, adapter 210 provides a connection between suction apparatus 500 and the vacuum source/waste container system (not shown). Distal tubes 420a,b are in fluid communication with and connected to adapter 210 through a Y-connector 414. Y-connector 414 is in fluid communication with the vacuum source (e.g., the vacuum source tube) either directly or indirectly. An indirect connection between Y-connector 414 and adapter 210 may be made, at least in part, through proximal tube 410. A direct connection is made when the Y-connector 414 is connected directly to adapter 210 or the vacuum source tube and proximal tube 410 is omitted. It is understood that Y-connector 414 and proximal tube 410 may be manufactured as separate elements and assembled prior to use. Alternatively, Y-connector 414 and proximal tube 410 may be manufactured as a single element in which the single vacuum input is extended to a convenient length for connection to adaptor 210 or vacuum source tube. The single vacuum input therefore functions equivalently to the proximal tube as the conduit between the adaptor 210 or vacuum source tube and the Y-junction of Y-connector 414. FIG. 6 illustrates an embodiment in which Y-connector 414 is configured to accept only a single size of proximal tube 410 and/or vacuum source tube. Y-connector 414 is described in more detail below.

As described above in the context of apparatus 300 (FIG. 4), distal tubes 320a,b may have a rigid or semi-rigid bend in order to form the apparatus over the lower mandibular arch (e.g., the incisal edge) in order to aid placement of the extraction ports in the buccal and/or lingual sulci and, optionally, such that the apparatus is retained in place by “hanging” the bend over the incisal edge. FIG. 4 illustrates one embodiment in which bend 325 is formed in distal tubes 320a,b. FIG. 6 illustrates an alternate embodiment in which each distal tube 420a,b is substantially straight/linear and the affixed to distal apparatus 428 which includes elbows 426, flexible tubes 440, extraction ports 430, and an optional tongue guard 460. Each of these elements is described in more detail below.

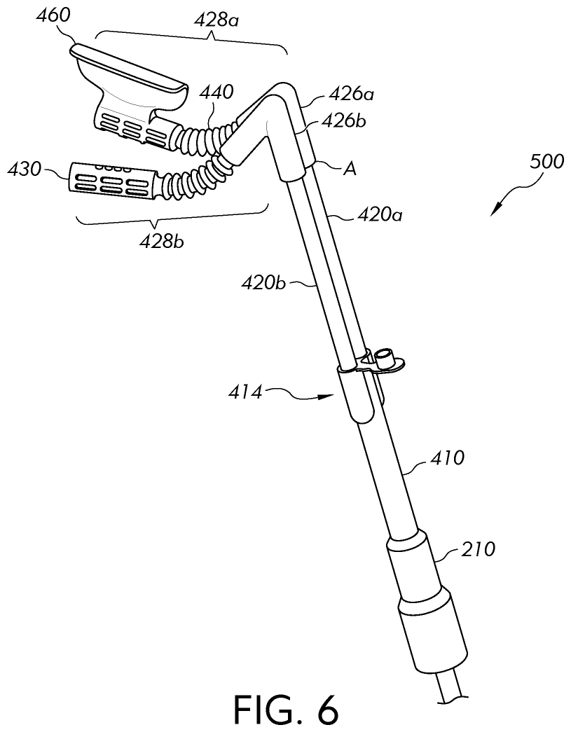

One function of Y-connector 414 is to create two or more vacuum and/or fluid flow paths from the single vacuum line at the proximal end of the suction apparatus. In some embodiments, Y-connector 414 includes ports 417a,b in fluid communication with the proximal end 416 and adapted to receive the proximal ends of distal tubes 420a,b respectively. While FIGS. 6-7 show Y-connector 414 having two ports 417a,b, Y-connector 414 may have three, four or more ports 417, each adapted to receive a proximal end of an associated distal tube 420.

In one embodiment, suction provided by the vacuum source/waste container system (not shown) to the proximal end 416 of Y-connector 414 is distributed evenly through the Y-connector 414 between ports 417a,b resulting in an even distribution of suction between the extraction ports 430a,b. In another embodiment, suction provided to the proximal end 416 is distributed unevenly through the Y-connector 414 to the ports 417a,b resulting in an uneven distribution of suction between the extraction ports 430a,b. In this case, one extraction port (e.g., 430a) may provide a higher amount of suction than another extraction port (e.g., 430b). The extraction port with the higher suction may be positioned in an area of the oral cavity where saliva or other fluid is expected to collect at a higher rate (e.g., in the lingual sulcus) while the extraction port with the lesser amount of suction may be positioned in an area where less saliva is expected (e.g., in the buccal sulcus).

As described in the context of FIG. 6, Y-connector 414 may form the junction between distal tubes 420 and proximal tube 410 or the junction between distal tubes 420 and adapter 210 (or vacuum source tube) if proximal tube 410 is absent. Y-connector 414 includes a distal end adapted to receive two or more distal tubes and a proximal end 416 adapted to receive the distal end of proximal tube 410 (or the distal end of adapter 210 or the vacuum source tube if proximal tube 410 is omitted). Y-connector 414 may be removed from proximal tube 410 (or adapter 210) and distal tubes 420a,b to be cleaned, sterilized (e.g., autoclaved) and/or replaced. Y-connector 414 may be attached to proximal tube 410 (and/or adapter 210) and distal tubes 420a,b via frictional fit, pressure fit, threaded unions, detents and/or other attachment mechanisms.

Dentists' chairs often are equipped with two vacuum source tubes, wherein the first suction line providing a lower amount of suction and comprising a smaller diameter tubing, and the second suction line providing a higher amount of suction and comprising a larger diameter tubing. These suction lines may attach to adapter 210, proximal 410, or attach directly to the proximal end 416 of Y-connector 414. FIGS. 7A-7B show a perspective view of an alternate configuration of Y-connector 414 which is adapted to accept vacuum source tubes having one of two different sizes (internal diameters). In this embodiment, proximal end 416 is adapted to engage either the first suction line or the second suction line (either/or but not both at one time). To do so, proximal end 416 includes two input connector portions 412a,b, with the first input connector portion 412a adapted to receive the first suction line (with a smaller diameter) and the second input connector portion 412b adapted to receive the second suction line (with a larger diameter). Input connector portion 412a comprises a cylindrical adapter of width Wₐ that generally corresponds to the inner diameter of the first suction line, and input connector portion 412b comprises a cylindrical adapter of width W_{b} that generally correspond to the inner diameter of the second suction line. First and second input connection portions 412a,b may each receive first and second suction lines respectively and be secured thereto by pressure fit, friction fit or by other attachment mechanisms. In some embodiments, Y-connector 414 includes longitudinal side ribs 413 or another structural feature that acts as a stop to the second suction tube (of larger diameter) when configured with the second input connector portion 412b. The ribs 413 also may facilitate easier gripping of Y-connector 414 during attachment or general handling. The step junction between portions 412a and 412b may act as a stop to the first suction tube (of smaller diameter) when configured with the first input connector portion 412a

In some dental procedures, it may be advantageous use fewer than all of the ports provided on the Y-connector. For example, the clinician may wish to begin the procedure with a single saliva extractor and then add a second saliva extractor during the procedure. One advantage of the inventive saliva extractor is modularity which provides the clinician with flexibility in extractor design without requiring separate extractor devices. Such flexibility may be provided by the Y-connector. In one embodiment, Y-connector 414 includes port plug 418 adapted to plug one of ports 417a,b when only one extraction port 430 is in use. For example, one port (e.g., port 417b) may be plugged using port plug 418 while another port (e.g., endcap port 417a) may be configured with distal tube 420a (and associated extractor port 430a). In this way, suction provided by the vacuum source/waste container system (not shown) to Y-connector 414 is only applied through the unplugged port (e.g., port 417a) to the extractor port 430a. Port plug 418 may be flexibly connected to Y-connector 414 using port plug tab 419 to secure it to suction apparatus 400 when not in use. Where Y-connector 414 includes more than two ports 417, additional port plugs 418 may be provided as needed.

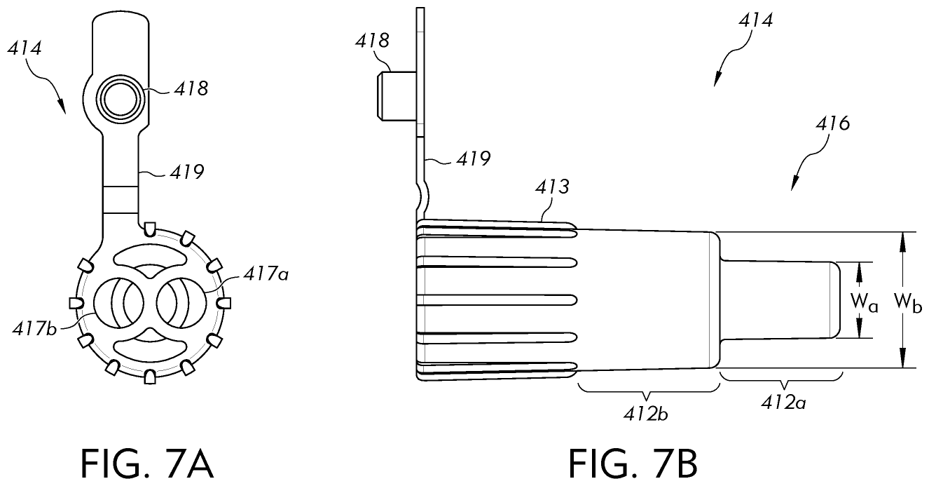

FIG. 8 shows a perspective view of distal apparatus 428 which comprises, in proximal to distal order, detachable elbow 426, flexible tube 440, and extraction port 430. Each component may be separately manufactured and then assembled, two components may be manufactured as a single piece and then assembled with the third, or the distal apparatus 428 may be manufactured as a single piece. It is understood that other manufacturing and assembly configurations are possible including, for example, elbow 426 may be manufactured as part of distal tube 420 and then assembled with flexible tube 440 and extraction port 430.

As with bend 325 in other embodiments, elbows 426a,b each include a bend at a sufficient angle to bridge the mandibular arch 200 so as to maintain proper placement of extraction ports 430a,b within the oral cavity. Elbows 426a,b may be rigid or semi-rigid as necessary to facilitate placement and user comfort. In some embodiments, elbows 426 are detachable from distal tubes 420, flexible tube 440, or both. Elbows 426 with different angles may be provided and interchanged depending on the angles needed for a particular patient and the desired positioning. Thus, in some embodiments the invention provides systems containing a plurality of elbows 426 (or matched pairs of elbows 426) having different angles, lengths, and/or tube sizes (outer and inner diameters) that may be interchanged by the user for each particular application or patient. Flexible tubes 340 may be formed to help facilitate proper placement of extraction ports 430a,b. In one embodiment, flexible tubes 340a,b include circumferential ribs (see FIG. 8) to allow tubes 340a,b to bend while providing strength to avoid collapsing when flexed. In another embodiment, flexible tubes 340 are adapted to be cut to the desired length by the user and to connect to either extractor port 430 or distal tube 420 after being cut.

FIG. 8 illustrates an alternative configuration for extraction port 430 that may be used with any of the embodiments described herein. Extraction port 430 comprises a hollow tube having an internal diameter approximately the same as that of the tube immediately proximal to which it is connected; flexible tube 440 in this case. It is understood that the internal diameter of extraction port 430 may be slightly larger or smaller, as desired. The side walls of extraction port 430 comprise a plurality of fenestrations 431 that are sufficiently large to allow the passage of fluid and small particulate matter. The fenestrations may have any convenient shape or number. It is desirable that extraction port 430 maintain a high level of rigidity. Extraction port 430 in FIG. 8 is formed from a rigid plastic which allows for the combined area of the fenestrations to be at least about 30%, 40%, 50%, 60%, or more of the outer surface area. Optionally, the end wall is open or sealed. FIG. 8 illustrates an embodiment having an open end wall. Extraction port 430 also comprises detents 470 and slots 472 on the outer surface of at least one side but preferably two (opposite) sides, or all sides. As discussed in more detail below, detents 470 and slots 472 are adapted to hold tongue guard 460 or other apparatus having matching detents and slots.

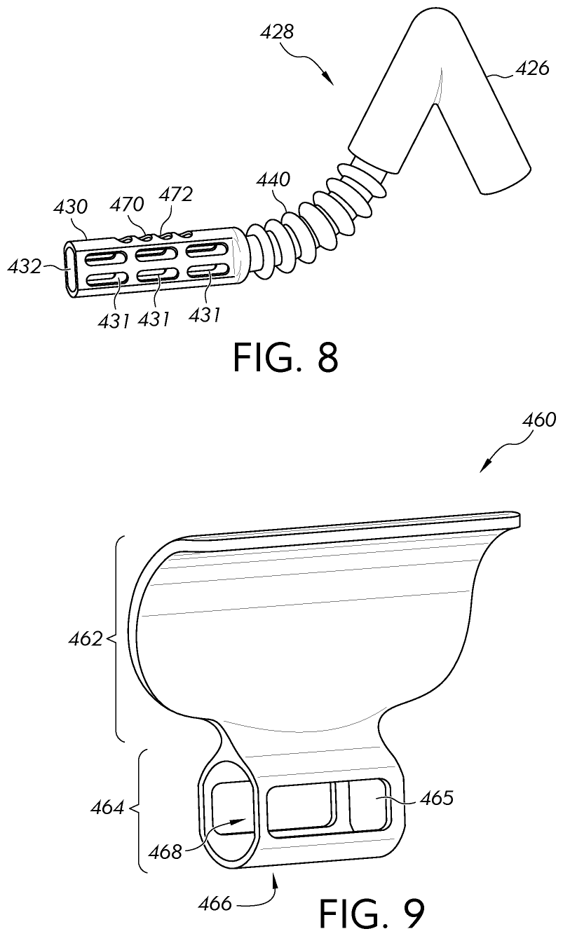

FIG. 9 shows a perspective view of tongue guard 460 which is intended to hold the tongue in a medial position and away from the lateral operating field (e.g., the teeth). Tongue guard 460 includes a guard portion 462 adapted to generally block the patient's tongue from other dental instruments implemented within the patient's oral cavity (e.g., a dental drill), and an attachment portion 464 adapted to attach the tongue guard 460 to an extraction port 430. Guard portion 462 generally comprises a thin wall that extends upward from attachment portion 464 a sufficient distance to obstruct the patient's tongue and to prevent accidental nicking of the tongue's lateral border by other dental tools. Guard portion 462 may have a length that is shorter, about the same, or longer than the length of extraction port 430. Generally, guard portion 462 is concave to tongue side for patient comfort. In some embodiments, guard portion 462 and/or tongue guard 460 is symmetrical so that the device may be positioned on either side of the mouth. In one implementation, the guard portion 462 is about 1.125 inches long, however other lengths also may be used.

The attachment portion 464 includes receptacle 466 with through-opening 468 adapted to receive an extraction port 430 from either side. The inner circumferential cross-section of through-opening 468 corresponds to the outer circumferential cross-section of the extraction port 430 so that the extraction port 430 may be received longitudinally into through-opening 468 and held therein. Depending on the placement of the associated extraction port 430 (e.g., whether the port 430 is positioned within the patient's left lingual sulcus or right lingual sulcus) the tongue guard 460 may be oriented on the extraction port 430 with its curvature arching to the right or the left respectively (towards the tongue).

Through-opening 468 and extraction port 430 may include corresponding geometric elements (e.g., straight side walls as shown in FIGS. 8-10) that prevent receptacle 466 from rotating about the longitudinal axis of extraction port 430. The inner wall of through opening 468 also comprises a complimentary engagement system to that present on the outer surface of extraction port 430. As illustrated here, the attachment system comprises detents 470 and slots 472. In some embodiments, tongue guard 460 is slidably engaged with extraction port 430 to facilitate proper and convenient positioning within the subject's mouth. The inclusion of a slidable but reversible engagement system (e.g., detents 470 and slots 472) advantageously securely locks tongue guard 430 into the desired location but also allows for repositioning, removal, and/or reversal during the procedure.

Attachment portion 464 further comprises fenestrations 465 to allow the passage of fluid and debris though fenestrations 431 of extraction port 430. Fenestrations 465 may or may not match fenestrations 431 but usually do not. As illustrated in FIG. 9, attachment portion 464 comprises fewer but larger fenestrations 465 than fenestrations 431.

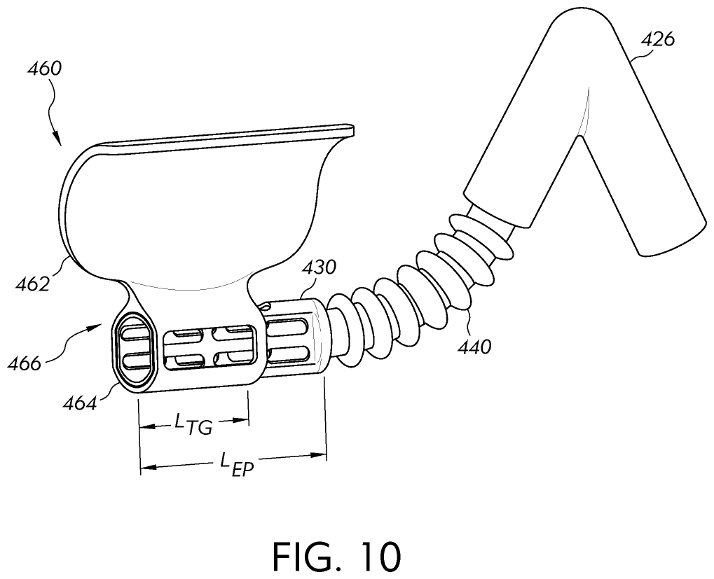

FIG. 10 illustrates an assembled distal apparatus 428 comprising a tongue guard 460. The longitudinal length L_{TG} of tongue guard receptacle 466 may be less than the longitudinal length L_{EP} of extractor port 430. This feature also allows tongue guard 460 to be slidably placed at different positions along the length L_{EP} of extractor port 430 depending on its area of need within the oral cavity. In one implementation, extractor port 430 includes detents 470 and/or slots 472 on its outer circumferential surface (e.g., on its top surface as shown in FIG. 8) and receptacle 466 includes corresponding slots and/or detents on its inner circumferential surface (e.g., on its inner top surface (not shown)). With the receptacle 466 and extractor port 430 configured, the detent-slot combinations may mate to releasably secure receptacle 466 at a desired location on extractor port 430. It is preferable that the detent-slot combinations adequately hold receptacle 466 (and the overall tongue guard 460) in its position on extractor port 430 during use of the suction apparatus 400, and that tongue guard 460 may be removed from the extractor port 430 without excessive force when desired.

In one implementation, the detent-slot combinations are configured to hold the receptacle 466 at selectable positions along the extractor port 430 such as (without limitation): (i) with its distal end flush with the distal end of the extractor port 430 (as shown in FIG. 10), (ii) at a position 0.083 inch in from the flush position, (iii) at a position 0.167 inch in from the flush position and (iv) at a position 0.250 inch in from the flush position. It is understood that the detent-slot combinations may be placed at any desired location(s) along the extractor port 430 to secure the receptacle 466 thereto.

Proximal Tube and Adapter

A proximal tube as described herein provides a fluid connection at its proximal end with a suction source and contains and directs fluid and debris entering the suction apparatus through the extraction ports. The proximal tube may be substantially rigid, formable, semi-flexible, or flexible. It may comprise any standard high-volume evacuator (HVE), saliva ejector (SE), or aspirator tubing. The inner-bore diameter may range from ⅛″ up to 2″. The proximal tube may have any suitable wall thickness. The proximal tube may be smooth, corrugated, coiled, or any combination thereof, and may be substantially straight, curved, L-shaped, or in any other suitable linear configuration. The proximal tube may be made from extruded vinyl, silicone, polyvinylchloride (PVC), nylon, or other suitable tubing material. In some embodiments, the proximal tube is made from biodegradable materials such as plant-based polymers, paper, and bamboo.

The adapter 210 may be any suitable dental tubing coupler. For example, adapter 210 may be threaded or unthreaded; may have a “quick disconnect” barb insert fitting; and/or may have a flow-adjust and/or shutoff valve. The adapter may comprise PVC, nylon, steel, brass, aluminum, or other suitable material or combination of materials. Adapter 210 may be substantially straight, L-shaped (i.e., “elbow”), or otherwise angled. The adapter 210 may be rigid or may have a swivel joint or ball-and-socket joint.

Material Extraction Ports

Distal tubes are in fluid communication at their distal ends with the material extraction ports. The material extraction ports are sufficiently porous to permit saliva and other oral fluids and, optionally, small particulate debris to pass from the oral cavity into the distal tubes. In some embodiments, the porosity of the extraction ports is small enough such that oral tissues (e.g., tongue, cheek, lips, etc.) are not trapped by suction, thereby causing discomfort to the patient and impeding the extraction of saliva. Extraction ports may comprise any convenient shape and suitable porous material. In preferred embodiments, material extraction ports 130 are substantially cylindrical and have a greater diameter than that of the distal tubes. In some embodiments, extraction ports are manufactured from cotton rolls having a central bore in fluid communication with the distal ends of distal tubes.

Material extraction ports may be of substantially uniform composition, or may optionally be perforated, i.e., disposed with a series of holes along the surface to permit increased flow of gases and fluids. Thus, material, e.g., saliva, flows through the nap and/or surface holes and into the distal tubes, down into the proximal tube, and then may be collected or discarded as waste. Alternatively, the material extraction ports may have 1, 2, 3, 4, or more additional holes of any suitable size or location on the surface for receiving material from a patient's oral cavity.

In some embodiments, the material extraction ports comprise a solid cap fitting over the distal end of the distal tubes the caps having a variously-shaped openings, e.g., circular, cross-shaped, star-shaped, polygonal, etc., over the opening to the lumens of the distal tubes.

The present invention comprises a combination of several modular components. Although certain combinations of these modular components have been described as final suction apparatus assemblies, it is understood that a suction apparatus may be formed by any combination of suitable modular components according to the principles described herein. Thus, the particular assemblies illustrated in the figures are not intended to be limiting but merely illustrative of the inventive suction assemblies.

The invention has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein.

Other embodiments are within the following claims. In addition, where features or aspects of the methods are described in terms of Markush groups, those skilled in the art will recognize that the invention is also thereby described in terms of any individual member or subgroup of members of the Markush group.

1. A saliva extractor comprising:
(a) a Y-connector having a single vacuum input, a first output, and a second output, wherein the first output and the second output are in fluid communication with the single vacuum input, and wherein the single vacuum input is adapted for connection to a vacuum source tube and waste container;
(b) a first tube and a second tube each having a proximal end and a distal end, wherein the first tube and the second tube are each adapted on the proximal end for connection to the first output and the second output, respectively; and
(c) a first extractor assembly and a second extractor assembly in fluid communication with the first tube and the second tube, respectively, wherein the first extractor assembly and the second extractor assembly each comprise in a proximal to distal order:
a rigid or semi-rigid elbow configured to support the saliva extractor over an incisal edge of a subject;
a flexible tube; and
an extraction port comprising fenestrations configured to allow passage of fluid into an extraction port interior and sized for placement within a buccal sulcus or a lingual sulcus of the subject.

2. The saliva extractor of claim 1, wherein the single vacuum input is configured to accept two or more differently-sized vacuum source tubes.

3. The saliva extraction of claim 1, wherein the Y-connector further comprises a backflow prevention valve.

4. The saliva extractor of claim 1, wherein the rigid or semi-rigid elbow of the first extractor assembly and the rigid or semi-rigid elbow of the second extractor assembly are detachably connected with the first tube and the second tube, respectively, and
wherein the rigid or semi-rigid elbow of the first extractor assembly and the rigid or semi-rigid elbow of the second extractor assembly and the first tube and the second tube, respectively, are unitary elements.

5. (canceled)

6. The saliva extractor of claim 1, further comprising a tongue guard attached to the extraction port of either the first extractor assembly or the second extractor assembly, wherein the tongue guard is configured to hold a tongue of the subject in a medial position relative to the extraction port.

7. The saliva extractor of claim 6, wherein the tongue guard is slidably engaged in a longitudinal direction with the extraction port of either the first extractor assembly or the second extractor assembly, and
wherein the tongue guard and the extraction port of either the first extractor assembly or the second extractor assembly comprise detents and grooves adapted to hold the tongue guard in one of a plurality of longitudinal positions on the extraction port.

8. (canceled)

9. The saliva extractor of claim 1, wherein the single vacuum input of the Y-connector is adapted to receive a vacuum input tube having a first diameter or a vacuum input tube having a second diameter, wherein the first diameter is larger than the second diameter.

10. An apparatus comprising:
a proximal tube having a first diameter, wherein the proximal tube is rigid, semi-rigid, or formable and adapted on a proximal end for connection to a suction and waste container apparatus; and
two or more distal tubes each terminating in a porous extraction port and each having a second diameter smaller than the first diameter, wherein the two or more distal tubes are flexible and in fluid communication with the proximal tube,
wherein each porous extraction port is sized for placement within a buccal sulcus or a lingual sulcus of a subject and, wherein each porous extraction port comprises a central lumen in fluid communication with one of the two or more distal tubes.

11-13. (canceled)

14. An apparatus comprising:
a first tube and a second tube each having a proximal end and a distal end, wherein the proximal end of the first tube and the proximal end of the second tube are each adapted for connection to a suction and waste container apparatus;
a first flexible tube and a second flexible tube each in fluid communication with and attached to the distal end of the first tube and the distal end of the second tube, respectively;
a first porous extraction port and a second porous extraction port distal to and in fluid communication with the first flexible tube and the second flexible tube, respectively, wherein the first porous extraction port and the second porous extraction port are sized for placement within a buccal sulcus or a lingual sulcus of a subject.

15. The apparatus of claim 14, further comprising a first rigid or semi-rigid elbow tube disposed between the first flexible tube and the first extraction port, and a second rigid or semi-rigid elbow tube disposed between the second flexible tube and the second extraction port.

16. The apparatus of claim 14, wherein the first tube and the second tube are rigid, semi-rigid, or formable.

17. The apparatus of claim 14, wherein the first tube and the second tube each comprise a bend in a distal half.

18. The apparatus of claim 14, wherein the suction and waste container apparatus comprises a suction source and a waste container.

19. The apparatus of claim 14, wherein the first porous extraction port and the second porous extraction port each comprises a central lumen in fluid communication with the first tube and the second tube, respectively.

20. (canceled)

21. The apparatus of claim 14, wherein the subject is a human.

22-23. (canceled)

24. The apparatus of claim 10, wherein the suction and waste container apparatus comprises a suction source and a waste container.

25. A method for extracting saliva from a subject's mouth comprising:
(a) providing the apparatus of claim 14;
(b) placing the first porous extraction port in the lingual sulcus or the buccal sulcus;
(c) placing the second porous extraction port in the lingual sulcus or the buccal sulcus; and
(d) applying suction to the apparatus, wherein the suction is sufficient to extract saliva from the subject's mouth through at least one of the first porous extraction port or the second porous extraction port.

26. The method of claim 25, wherein the first porous extraction port is placed in the lingual sulcus and the second porous extraction port is placed in the buccal sulcus.

27. The method of claim 25, wherein both the first porous extraction port and the second porous extraction port are placed in lingual sulci.

28. The method of claim 25, wherein both the first porous extraction port and the second porous extraction port are placed in buccal sulci.
